(19) United States
(12) Patent Application Publication
(10) Pub. No.: US 2013/0036144 A1
(43) Pub. Date: Feb. 7, 2013

(54) METHOD FOR CONVERTING POINT ADDRESS DATA

(71) Applicant: Steve Ladd, Meriden, NH (US)

(72) Inventor: Steve Ladd, Meriden, NH (US)

(21) Appl. No.: 13/520,199

(22) PCT Filed: Dec. 31, 2009
(86) PCT No.: PCT/US09/69891

§ 371 Date: Jul. 2, 2012

(51) Int. Cl. G06F 17/30

(52) U.S. Cl. 707/809; 707/E17.005

(57) ABSTRACT

Embodiments of the present invention relate to a method for converting a database of point address data into a database of address range data using a computer, wherein each point address comprises an address number, a street name and a geographical location. The method comprises assigning each point address to a chain based upon its street name; ordering the point addresses in each chain according to their geographical location; determining the direction and range of the road numbers in at least part of at least one chain; and storing the direction and range data as address range data.

### FIELD OF THE INVENTION

This invention relates to a method for converting a database of point address data into a database of address range data using a computer.

### BACKGROUND TO THE INVENTION

In digital map databases, address attribution is usually associated with polyline representations of streets. Typically each street is broken up into intervals which begin and end at adjacent junctions, and the beginning and ending addresses of each side of an interval are recorded. This is known as Block Face Accuracy, as the address range for each individual block face is recorded. The approximate position of a particular address can then be interpolated from the data as required.

In the US, address ranges have typically been seeded from US Census information or from the Postal Service.

More recently the precise location of individual addresses for buildings and lots has become available. When geocoding (determining the location of an address), utilization of point addresses is much more precise and accurate than address ranges.

The benefits of more precise positional information in mapping systems is well known and sought after; U.S. Pat. No. 5,739,573 B2 discloses a method for providing improved positional accuracy by interpolating from point data. However, this method does not offer a way to turn several point addresses into an address range, instead being limited to interpolating address coordinates based upon address range data and the separate external point data (see claim 1 of the application).

However, address ranges are still being used for geocoding both in legacy systems and because address ranges use much less memory. It takes much less space to store 4 addresses per block for address ranges than potentially hundreds of point addresses.

In order to verify and update address ranges, it has become necessary to extrapolate from point addresses. However this is not always easy as addresses don't necessary happen in sequence, aren't necessarily all numbers, don't have to similar sequences on both sides of the street and in general don't always follow general rules of thumb.

Therefore where address ranges are interpolated from point addresses, they are typically manually imputed.

The US patent application with publication number 2005/0034074 A1 describes a mapping system in which aerial photographs are used to correct geocode data for street addresses. In this system it is a user who corrects the map using local knowledge (see FIG. 6 of the application).

Therefore a method for adequately extrapolating from point addresses to address ranges would be very useful, both for checking and updating existing address range databases and creating new ones. It is an aim of the present invention to provide such a method.

### SUMMARY OF THE INVENTION

In pursuit of this aim, a presently preferred embodiment of the present invention provides: a method for converting a database of point address data into a database of address range data using a computer, wherein each point address comprises an address number, a street name and a geographical location. The method comprises: assigning each point address to a chain based upon its street name; ordering the point addresses in each chain according to their geographical location; determining the direction and range of the road numbers in at least part of at least one chain; and storing the direction and range data as address range data.

In this way, the invention provides a method for automatically converting point address data into address range data. The range data can then be used directly, for example in navigation systems, or for checking existing range data, or simply stored for future use.

The street names will typically be the names of a street or road onto which at least one building faces. However, the street names may indicate paths, corridors or any other form of access. Similarly, address numbers will typically be the numbers of buildings, but may also refer to empty lots, individual rooms or any other collection of discrete, numbered physical locations. For example, the program could be used to convert data relating to the position of numbered rooms in a building or group of buildings.

Geographical location is typically given in measurements of longitude and latitude. However, it may be desired to have the invention function with other geographical measurements. For example, the geographical locations may be given as distance and direction from one or more fixed points. The geographical locations may also include a measurement of height where appropriate, such as when handling addresses over a number of different levels.

As well as being chained by street name, point addresses may also be divided by other known data such as zip codes in the US or other postal codes elsewhere. The point addresses may also be divided by geographical location. For example, in a computer carrying out a method according to the invention, the user may only wish to analyse the point addresses in a box between lines of latitude at 51 degrees 30.7 minutes north and at 51 degrees 31.1 minutes north, and between lines of longitude at 0 degrees 6.3 minutes west and at 0 degrees 7.2 minutes west. Presented with a larger database, the computer can be programmed to only use those addresses which fall within these limits, based upon the geographical location of each point address.

Typically, the method according to the invention further comprises finding the junctions between chains by noting points where chains meet; and dividing at least one chain into intervals, each interval being defined as a section of chain between two subsequent junctions, before determining the direction and range of the address numbers in at least part of at least one interval and storing the direction and range data as address range data.

The junctions between chains can be determined by analysing the point address data itself, and assuming that a junction occurs wherever two chains meet. Alternatively, the junctions can be determined by comparing the point address data to a map of the streets to be analysed or to a list of expected junctions.

Typically, the method further comprises dividing at least one chain or interval into sides, each side of a chain or interval corresponding to a side of the street, before determining the direction and range of the address numbers in at least part of at least one side and storing the direction and range data as address range data.

By dividing the chains up into sides, the invention allows further analysis of the address numbers, for example some embodiments will further comprise determining the parity of the address numbers in at least part of at least one side. This determination of parity can be stored as part of the address range data. It can also be used for checking the point address data as explained below.

In a further embodiment, the invention further comprises checking and correcting the point address data before determining the direction and range of the address numbers in at least part of at least one side and storing the direction and range data as address range data.

In this way the invention provides a way to correct for erroneous point address data, and hence ensure the more complete automation of any method according to the invention. The point address data can be checked and corrected in a number of ways. For example the point address data is typically checked by analysing the address numbers, street names and geographical locations to ensure that they comply with an expected format. The details of this format will vary depending upon the use to which the invention is put, but it will typically involve checking that address numbers are all numbers and of an expected type and range, and that the street names and geographical locations are both use the expected symbols in the expected format.

In addition, the point address data may be checked by determining the prevailing direction of count of address numbers for at least part of at least one chain. Where this is the case, the point address data is typically corrected by swapping, deleting or replacing any address numbers which are out of position given the prevailing direction of count.

The direction of count of address numbers is typically determined by creating a vector of address numbers and geographical locations for at least part of a chain.

Similarly, the point address data may checked by determining the prevailing parity of address numbers for at least part of at least one chain. Where this is the case the point address data is typically corrected by swapping, deleting or replacing any address numbers which are out of position given the prevailing parity.

The point address data may also be checked by searching for gaps in the address numbers of at least part of at least one chain. Where this is the case the point address data is typically corrected by creating new address numbers in that gap. The new address numbers may be created by interpolating from the address numbers of the point addresses surrounding the gap. The gap may be divided and each division supplied with at least one address number. If a gap is expected, for example if a gap in address numbers is recorded in the postal records, then a computer carrying out the method according to the invention may be programmed to ignore the gap.

A method according to the invention may further comprise checking and correcting the address range data. This checking will usually comprise a check that every address range contains a valid range and/or that the ranges do not overlap. The checking will also typically comprise comparing the address range data with at least part of the original point address data to ensure that the parity and/or direction of count are consistent.

A further embodiment of the invention provides a method for checking a first set of address range data in a database, the method comprising: acquiring point address data for the area to be checked; converting the point address data into a second set of address range data using any of the methods described above; and checking the first set of address range data against a second set of address range data.

A still further embodiment of the invention comprises a method for compressing point address data, the method comprising converting the point address data into a set of address range data using any of the methods described above.

The invention also comprises a computer program product directly loadable into the internal memory of a digital computer, comprising computer software code for performing a method as claimed in any preceding claim.

Advantages of these embodiments are set out hereafter, and further details and features of each of these embodiments are defined in the accompanying dependent claims and elsewhere in the following detailed description.

### BRIEF DESCRIPTION OF THE DRAWINGS

Various aspects of the teachings of the present invention, and arrangements embodying those teachings, will hereafter be described by way of illustrative example with reference to the accompanying drawings, in which:

FIG. 1 is a block diagram illustrating the division of point address data in a computer program designed according to the invention;

FIG. 2 is an illustration of an ideal interval in a street for analysis by the invention;

FIG. 3 is an illustration of a more realistic interval; and

FIG. 4 is an illustration of a street on which the address numbering changes at a junction.

### DETAILED DESCRIPTION OF PREFERRED EMBODIMENTS

Preferred embodiments of the present invention will now be described with particular reference to an automated process for using point addresses to validate existing address ranges on street segments, and optionally to change the address range on those segments. See Appendix A for a glossary of some of the terminology used throughout this description.

FIG. 1 is a block diagram illustrating the division of point address data 1 in a computer program called Adept which is designed according to the invention. In a raw state, each of the point addresses will comprise a street address, itself typically comprising a number, a street name and a ZIP code, and a geographical location which may for example be given as a measure of latitude and longitude on the Earth's surface. Before being converted to ranges, the point address data should be checked for accuracy and correctness. Therefore Adept is designed to carry out a checking process before converting the point address data.

In order to be of use, the point address data 1 must be organised according to the network of streets along which the addresses are ranged. A first step is to organise the point address data 1 into chains 2.

Addresses are chained by name, and typically also ZIP code. Each chain 2 therefore comprises every point address on a given street within the bounds of a given ZIP code. These chains are named according the street which they represent, although in FIG. 1 these have been labelled Chain A, Chain B and so on. Only four chains are illustrated in FIG. 1 for clarity, but a computer program according to the invention can handle as many chains as is needed, given enough processing time.

Often where a street is discontiguous, so there is a gap between successive intervals, Adept will initially create two separate chains for that street. These chains can then be “snapped” to create a single chain. A chain may be discontiguous because the street that it is based on crosses an intersection with an offset. Adept therefore checks the data it is analysing for chains with identical names which end near to each other, and snaps them together if they are less that 300 micro degrees (about 33 metres) apart. The discontiguous chain is then treated as a single chain from that point onwards. Alternatively, a chain may be discontiguous because the street is interrupted by a feature, such as a park. Therefore Adept will check for chains with identical names which end within 1500 micro degrees (about 165 metres) of each other. However, these chains will only be snapped together if the street address directions are the same. See below for details on how Adept analyses street address directions. The user is able to change the distances used for snapping chains if they wish.

Separate chains are initially created for discontiguous the same street; where portions of the same street that are separated by a significant distance. This will typically happen for one of two reasons

In Adept, some types of street are typically assigned to two chains, for example cul-de-sacs have one chain for the stem and one chain for the bulb. Similarly, traffic circles have one contiguous chain as well as one or more side loops.

The chains 2 are composed of segments, each segment being one edge in the polyline representation of the street. Every segment is assigned a segment ID by Adept. The point where at least two segments meet is a node. Chains are created by starting at an arbitrary address and walking from this address from segment to segment in both directions for as long as the street name remains constant. For this reason traffic circles will typically have one half of the circle in one chain, and the other half in another. One end of the chain is identified as the From end, based upon the direction of count of the address numbers.

In order to find junctions, Adept will walk each chain from one end to another, examining each node in the chain for an intersecting segment from a different chain. Therefore a junction is defined so as to include any node where at least two chains meet. Adept will also treat dead ends, where a chain stops without meeting another chain, as junctions. The first and last nodes on a chain will often be dead ends, or valence one nodes (see Appendix A), although they may also be junctions. In searching for junctions, Adept will ignore A74 roads (driveways). Adept creates a vector of junction segment IDs for each junction found, using a value of 0 for a Dead-End.

Adept will gel, meaning record, any valence three or greater chain. A valance three chain is one in which there is a junction where more than two chains meet. To gel the chain, Adept stores its details in a file created storing this information.

The section of a chain between two junctions is an interval, and the chains 2 illustrated in FIG. 1 are further subdivided into intervals 3. Again, FIG. 1 illustrates only the subdivision of chain A, and only three intervals within chain A, but there is no upper limit on the number of intervals to be handled. If it is required then chains or intervals can also be further subdivided, for example by geographical location. Only A** segments (see Appendix A) are chained.

One further subdivision is necessary for Adept. Each interval 3 is divided into sides 4. The addresses are split into sides according to which side of the street they occupy. The sides of the interval are then labelled Left and Right sides depending upon which side of the street they occupy when standing at the From end of the chain and looking along its length.

### Address Correction Algorithms

Having chained the addresses in this fashion, Adept will then carry out a number of checks upon the addresses, and attempt to correct any errors that are detected. There are six steps to this checking and correction process.

### 1. Pre-Process Point Addresses

Firstly, Adept will remove any invalid addresses, converting them to an unaddressed range. What constitutes an invalid address will depend in part on the standards that Adept has been assigned. In the US, for example, this will include the Federal Information Processing Standard (FIPS) that is being used.

To check the addresses of each interval, Adept will analyse the address numbers from all the segments that make up that interval. The address numbers are analysed with respect to their location to check direction, parity and sequencing consistency. That is to say that all houses for a particular side within a particular interval must have the same direction, parity and be sequential. Otherwise Adept will log the error and correct the numbers if possible.

Ideally, each interval will contain at least four point addresses that can be used to determine the actual Left/Right From/To address range data for that interval. Typically, at least the four addresses at the ends of a street interval, that is one at each end on each side of the street, will be used to determine this information

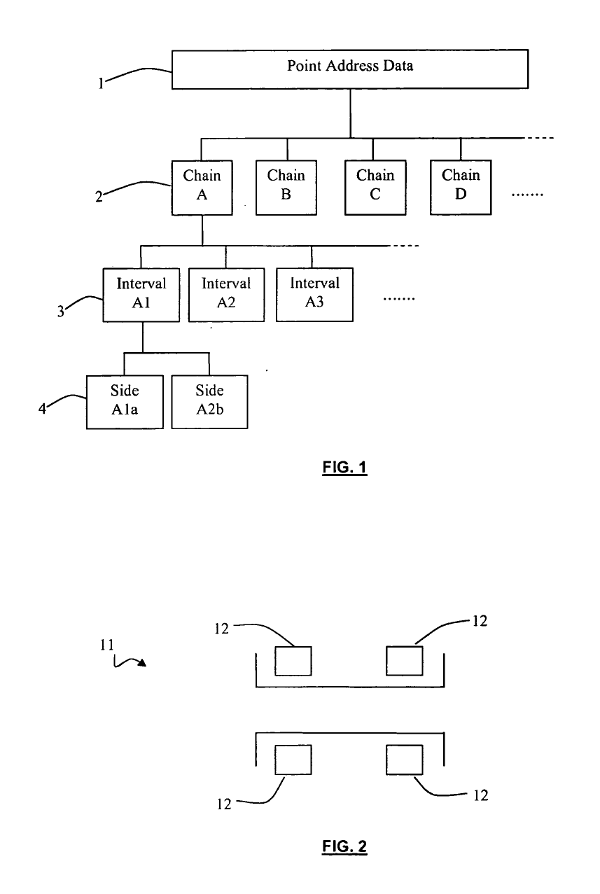

FIG. 2 illustrates the simple case of one street interval 11 that has exactly four point addresses 12 attached to the ends of the interval 11. In this case, the four point addresses 12 correspond to the address ranges, and an address range can be directly derived for each side of the interval.

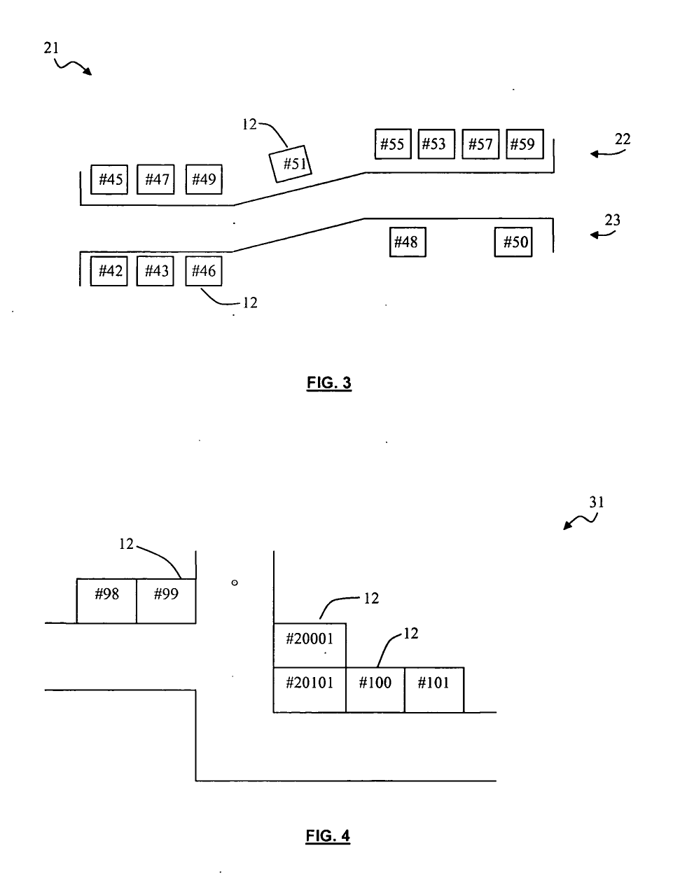

However, typically an interval will be more complicated than this. An example is illustrated in FIG. 3, which is a graphical illustration of data provided to Adept regarding an interval 21. There are several point addresses 12 in this interval, each illustrated as a box with the house number written within the box. In this case, all the point addresses 12 on each side will be analyzed for parity and direction consistency by Adept.

Adept generates a vector of house numbers of the form (HouseNumber, % loc), where % loc indicates a geographical location, for each side of the interval 21. This vector allows Adept to determine the direction of the house numbers. If more than one house falls at same % loc then the direction will be determined from the prevailing direction of the other addresses.

The parity of one side of an interval is determined by examining all the house numbers to determine how many are even and how many are odd. At least 80% of the houses in a side must have the same parity for that side to be classified as odd or even. Otherwise the parity of that side is classified as mixed.

In the example shown in FIG. 3, Adept will conclude that the first side 22 is odd, and that the second side 23 is even. The second side 23 contains an error whereby one point address has been mislabelled as an odd number, however four out of the five houses on that side are still even, and therefore the 80% test is passed.

### 2. Correct the Chain

In the case where there are inconsistencies between point addresses so that, for example, the direction of count appears to change for a few houses, Adept will always record these inconsistencies. If Adept is run with the correct parameters, as given in more detail in Appendix B, it will also use the prevailing parity and direction on the street chain to correct any inconsistency in the set of point addresses. Adept will log a warning message whenever any change is made to the recorded point addresses, as well as recording the altered addresses in a gel. Typically such inconsistencies are caused by a point address being out of sequence, or having the wrong parity compared to the majority of the points.

At least 40% of the intervals on each side of a chain must be addressed in order for Adept to attempt address correction of any form on any part of that chain. Otherwise no part of the chain will be updated, although all errors will still be logged.

For each interval on each side of the street, all the segments that comprise the interval are consolidated by Adept into a single range. Adept then creates a vector (HouseNumber, % loc) for each range, where % loc is an indication of geographical location. Using this vector, Adept can determine the direction and parity of the ranges. Where some addresses in a range are out of sequence, Adept will only renumber the addresses in a chain if at least 80% of the addresses in that chain count in the same direction according to the vector (HouseNumber, % loc). So, for example, on the first side 22 in FIG. 3, Adept will swap #55 and #53, as these two numbers occur out of sequence with the rest of the side.

Similarly, where the parity of an address does not match the parity of the side it occupies, Adept will renumber that address according to the prevailing parity and count as indicated by the vector (HouseNumber, % loc). Adept will only renumber the addresses in a side to correct parity errors if at least 80% of the addresses in that side exhibit the same parity, as Adept will only know the parity of a side if 80% of the addresses in that side exhibit the same parity. Therefore, on the second side 23 in FIG. 3, Adept will replace #43 with #44, in order to keep parity with the rest of that side.

Adept will also attempt to correct overlaps between ranges. This can be done by:
a) swapping two adjacent numbers if they are out of sequence and they are both within the range of the surrounding numbers. For example, if the house numbers on one side of a street are #2, #4, #6, #8, #12, #10 and #14, Adept will swap #12 and #10 so that they match the prevailing direction of count.
b) using a number that is in the expected range of an interval if one is outside this range. For example, in the sequence #2, #4, #60 and #8, Adept will replace #60 with #6.
c) deleting duplicates. For example, in the sequence #2, #2, #4, #6, Adept will delete one #2.
d) deleting a single number range that is out of sequence. For example, in the sequence #2, #4, #6, #60 and #8, Adept will delete #60.

Adept is run with a command line that can contain several flags which will control Adept's address correction behaviour. See Appendix B for a detailed description of the command line and these flags.

Adept will record any address correction in the file autofix.gel. Once Adept has been run, this gel can be reviewed by the user to ensure that the corrections made were accurate. The degree of correction carried out by Adept is controlled by the −aggr flag in the command line. Without the −aggr flag, Adept is limited to changing only two ranges in any chain. For this reason, when Adept is run without the −aggr flag there is a higher chance of overlaps happening due to inconsistencies in the point addresses.

Address correction will often result in gaps in the house numbers between segments in a chain. These gaps will often be corrected by stages 3 and 4 (filling in unaddressed ranges and padding address ranges). Where they are not they will typically not affect the eventual range and direction of addresses determined by Adept.

### 3. Fill in Unaddressed Ranges

Where a range is unaddressed, but is not marked as unadressable, Adept will attempt to provide at least one address for that range. For a gap comprising n unaddressed ranges, Adept will assign each range a value of x from 1 to n and then calculate one address for each range using the formula:

$${A}_{x} = x ( \frac{F - L}{n} ) + L$$

Where Aₓ is the address number assigned to range x;
F is the first address number after the gap;
L is the last address number before the gap; and
n is the number of unaddressed ranges in the gap.

The values of x count in the same direction as the direction of the address numbers in the chain as determined by the vector (HouseNumber, % loc) for the first addressed range in the chain, as described above. This ensures that the assigned values of Aₓ count in the same directions as the prevailing addresses for that chain.

Adept will always round off Aₓ to match the expected parity of the interval. Therefore if the prevailing parity of that side of the chain is even, all the values of Aₓ will be rounded off to the nearest even numbers. If the prevailing parity is odd, all the values of Aₓ will be rounded off to the nearest odd numbers. If the parity is mixed, all the values of Aₓ will be rounded off to the nearest whole number.

Where there are too few addresses available to assign one to each unaddressed range, Adept will assign addresses as many ranges as possible, leaving unaddressed ranges spaced evenly through the gap.

When assigning address numbers in this way, Adept will not use address numbers that are recorded in postal records as being unused, or which are recorded as being in a different postal code to the section of chain being addressed. If an unaddressed gap begins as a chain crosses into a new z4 area, and postal records indicate that the address numbers in that z4 area begin at a value y, Adept will take L to be:
y−2 if the interval is expected to have the same parity as y; or
y−1 if the interval is expected to have mixed parity, or the opposite parity to y.

Similarly, if an unaddressed gap ends as a chain crosses out of a z4 area, and postal records indicate that the address numbers in that z4 area end at a value z, Adept will take F to be:
y+2 if the interval is expected to have the same parity as z; and
y+1 if the interval is expected to have mixed parity, or the opposite parity to y.

### 4. Expanding Addresses

At this point, there will be at least one address in each addressable range of each chain, unless there are two few available addresses to provide one for each unaddressed range, as discussed above. Adept then pads the ranges, by adjusting the low and high addresses in each range so that all ranges have contiguous addresses based on the computed parity. Single address ranges are also expanded in this fashion.

Where the break between ranges is placed by Adept depends upon its starting parameters. If it is known that address ranges in the area to be analysed tend to break at 100, 200 and so on, Adept will attempt to pad addresses in adjoining intervals so that the nearest address number to the break is divisible by 100. Similarly, Adept can be set to pad addresses so that the nearest address number to a break is divisible by 25, or any other value desired.

Adept will also use postal code information when determining the correct address number to be next to a break between intervals. If the postal record information for a z4 area indicates that the lowest address number in a chain is y and the highest address number is z, then Adept will adjust the lowest and highest address numbers for that chain inside that area to match y and z.

The high and low address of an entire chain will also be adjusted to match postal records, if available, and if the difference is less than the allowable tolerance, otherwise up to the next highest 100, or down to the next lowest 100.

Adept will not pad or adjust the address numbers on either side of a break between intervals if they are contiguous.

Where no guidance is available as to the correct value for the address numbers closest to a break between intervals, Adept will use numbers midway between the highest address in the lower range, and the lowest address in the higher range.

### 5. Determine Address Ranges

Having corrected addresses and filled in gaps where appropriate, Adept can then determine the address ranges and directions of every side of every interval. The ranges are determined by taking the highest and lowest address number values of each side of each interval. The direction is determined using the vector (HouseNumber, % loc) as discussed above.

### 6. Final Check

Adept then performs a number of integrity checks. Single side checks (applied to each side of each interval) check that:
1. Every address range contains at least 2 valid addresses. These addresses can be the same, to indicate that a range contains only one address, and they can both be 0, to indicate that a range is unaddressed;
2. The parity is consistent;
3. The direction is consistent;
4. The addressing scheme is consistent, and either all addresses are numeric or that all addresses are alpha numeric with either the alpha or numeric portion as the consistent dominant portion;
5. The address numbers are in sequence;
6. There are no overlaps;
7. Acceptable gaps;
8. The range between junctions is less than 1000;
9. The range across junctions is less than 500; and
10. The range is in the expected Z4 range.

If any of checks 1 to 7 fail, then the integrity of the addresses on the chain is bad. If any of checks 8 to 10 fail then a warning is generated and logged by Adept.

Tests 8 and 9 are intended to highlight streets or intervals that may change direction and addressing at junctions. If the address range within an interval exceeds a threshold limit, typically set to 1000 addresses, Adept will generate a warning. Likewise if the address range between junctions exceeds a threshold, typically set to 500 addresses, Adept will generate a warning. The address range between junctions is measured using the midpoint of each adjacent interval.

FIG. 4 illustrates an interval 31 where the addressing changes at a junction. Each of the boxes 12 represents an address in the interval 31, with the house number written inside the box. The gap between #99 and #20001 will be identified by Adept as an exceeded range, hence generating a warning which will help a user to locate and fix the problems that this sort of erratic numbering can generate.

Adept also checks both sides of each interval that:
1. There are no overlaps;
2. High and low ranges agree; and
3. Junctions agree, unless there is an expected break between junctions.

If the data fails any of these checks, a warning is generated.

As mentioned above, Adept maintains error and status logs that track:
the status of all chains whether readdressed or not
any segments where point addresses and/or ranges were auto corrected
any unaddressed segments
any chains, intervals or sides of intervals not updated
any points that were adjusted to avoid range computation errors
any imputer errors
any parity or direction mismatches
any overlapping segments

See appendices C and D for a detailed list of the gel and log files created by Adept.

### Readdressing Existing Ranges

The addresses having been checked and corrected by Adept where appropriate, and the address ranges and directions determined to block face accuracy, this data (the actual ranges) can be compared to the older data (the existing ranges) that Adept has been directed to check.

Where Adept is being run in update mode, and not simply run to check the quality of recorded data, the existing ranges will be updated using the actual ranges.

By default, Adept attempts to get the best range based on the actual and existing ranges by using the following rules:
a) If a range is unaddressable, it is assigned a range of 0-0.
b) If an existing range contains no addresses, but is not marked as unaddressable, then Adept will return the actual range.
c) If the actual range contains no addresses, then Adept will return the existing range.
d) If the actual range lies within the existing range, Adept will return the existing range.
e) Otherwise Adept will return the actual range, which may be empty.

Unless the −p (partial range update) option is used, all ranges on both sides of a chain must be valid for that chain to be readdressed, i.e. all sides of the chain must have passed single side checks 1 to 7 in the final checks described above. If the −p flag is used then bad ranges may be blanked (set to 0-0) so that the valid ranges can be updated.

Imputing new address ranges is done independently on each side of a chain. If the imputer fails, the addresses for the segments in the range is set to 0-0 and the error is logged. Imputer failures can then be corrected manually.

Existing confidence codes are removed on updated and blanked segments. If both sides of a segment were successfully updated, the confidence code specified by the flag +cc is applied to that segment. If a segment was initially unaddressed and adept determines that the segment is still unaddressed, a new confidence code is not applied.

In any segment that is readdressed, Adept will compare the new address range with postal service address ranges so that the postal codes (zip codes in the US) can be changed to agree with postal service address ranges. If postal codes are missing for segments that have their range updated, Adept will apply a valid postal code where one is available from other sources. For example, if a range is updated and there is no postal zip for the updated side, the boundary zip can be used to update the postal zip.

Segments in the existing ranges that are uneditable, or which have an Address Accuracy Confidence Class Code specified by the −cc flag, will not be re-addressed.

If a chain contains only one address then that chain will not be updated. If a chain is unaddressed, i.e. it contains no valid point addresses, then the chain will not be updated. If both sides of a chain are marked as not to be updated (typically using a confidence code identified by the flag −cc) then the chain is not updated. If a section of a chain is marked as not to be updated using a confidence code, Adept will still attempt to fix overlaps by adjusting or deleting the adjoining sections. Adept will also attempt to fix gaps by padding the sections on either side of the protected section.

In addition, if there are address correction errors in more than 40% of the ranges within a chain, the chain will not be updated. As described above, address correction errors include invalid ranges (missing house number(s) or bad house number(s) in a range), invalid direction (some address numbers run contrary to prevailing direction), invalid parity (some address numbers run contrary to prevailing parity) and overlaps (two or more ranges overlap).

Chains (or segments if −p is used) are recorded as Updated if they have been readdressed, and are recorded as Not Changed if they haven't. Chains may be Not Changed because the existing range is the same as the range Adept has computed from the point addresses, or alternatively chains may be Not Changed because an address computation error occurred. Ranges that are Not Changed due to address correction errors are gel'd. For changed address ranges on segments, the existing confidence codes are removed from the updated segments and a new CC (Confidence Code) is applied. The new CC is appended to segments where the new computed address range is the same as the existing range.

Adept may alter addresses incorrectly if the segment data is not accurate, for example if there are wrong or missing Zip codes, or if there are name errors such as a confusion between primary and alternate names. If Adept encounters any errors during or after addressing, segments may sometimes be blanked (deleted). There will almost always be some blanked segments if −p (partial update) flag is used because imputer errors during readdressing can result in blanked segments. The User can review the file readdressed.gel for lines such as “Adept: (W10) Addressed range (% s-% s) removed”, and manually correct the address ranges on these segments where necessary.

### False Positives

There are cases where Adept can incorrectly apply address ranges. This may occur when there are two discontiguous valence two or three chains with the same name, so that Adept interprets the two chains as being part of the same road even when they are not. It may also occur in some valence three chains, such as where the street is double digitized (such as a dual carriageway), or includes a Y or T junction where all three arms have the same name.

Many chains that meet these conditions will still be correctly re-addressed, but they are also identified in the V2.gel and V3.gel as appropriate (see Appendix C for a list of gel files). These gels should be used to verify that Adept correctly addressed these chains. Any addressing errors will often also show up in the overlaps gel, the gel that tracks any addresses that appear in more than one chain.

### Return Codes

Once it has run, Adept can return three basic codes, according to its results. These are:
0=all chains pass
−1=all chains fail
1=some of each

### Cul-de-sac Specific Processing

Cul-de-sacs are handled separately from other streets by Adept. A cul-de-sac is defined as a loop of A61 segments, which form the bulb, attached to at least one connecting road, which is the stem.

A Stem is comprised of one or more A** segments (not A61 segments) which intersect the bulb at one end and connect to a junction at the other. Other intersecting features (B and F road segments for example) are ignored by Adept when determining the bulb and the stem.

Cul-de-sacs are identified by Adept by searching all A61 segments, and chaining these segments to create individual cul-de-sacs bulbs. Each bulb is split in half, each half defined to be all the segments comprising between 45% and 55% of the total length of the bulb, starting from one arbitrary side of the stem. If the segments are too large to be divided in this way, a segment is split to achieve a 50% length in both halves.

Adept will check both the bulb and the stem of each cul-de-sac for addresses. Bulbs without any addresses are not processed by Adept. Similarly, addressing must exist on both sides of the stem.

Each half of the bulb is associated with one side of the stem. The existing left and right side address ranges of the stem are then used to determine the range of addresses across all segments that comprise each half of the bulb. The readdressed bulb is given the post code of the stem.

Semi-Automatic Mode from Beguile

Adept can also be run from within Beguile, a street network editing system. In order to use adept from Beguile, the file custom.cmd must have the following entry:

### CUSTOM_COMMAND 1

MENU=Addresses from Points

### HOT_KEY=Alt<Key>a

MESSAGE=Addressing Selected Segments from Address Points . . .
COMMAND=adept<DBPATH>-in segs.txt-o<output directory>+update

### OPTIONS=NO_TERM SELECTED_SEGS REFRESH

### OUTPUT_FILE=./Adept/adept.log

### DISPLAY_FILE=./Adept/adept.log

You can also use the −limits option in the I) bar to tell Adept to use the first and last addresses of the selected segments as constraints, and override Z4 padding.

Within Beguile, a chain of segments can be manually selected, and the point addresses on the selected segments used for readdressing. This way, a particular portion of a larger chain can be readdressed. For example if, when processing map data for a town, Adept blanks 5 consecutive intervals out of a total of 30 on Main Street because there was an erroneous point on one segment that caused 5 overlaps, then the user can manually fix (or delete) this error before selecting just the 5 blanked segments for re-addressing by Adept.

### Localisation and Other Adaptations of Adept

Adept, as described above, is adapted for use with the US address system. However, it will be obvious how it can be adapted to other postal systems by adjusting the rules so that, for example, the system can use English post codes instead of American zip codes.

It will also be well understood by persons of ordinary skill in the art that whilst the preferred embodiment implements certain functionality by means of software, that functionality could equally be implemented solely in hardware (for example by means of one or more ASICs (application specific integrated circuit)) or indeed by a mix of hardware and software. As such, the scope of the present invention should not be interpreted as being limited only to being implemented in software.

Lastly, it should also be noted that whilst the accompanying claims set out particular combinations of features described herein, the scope of the present invention is not limited to the particular combinations hereafter claimed, but instead extends to encompass any combination of features or embodiments herein disclosed irrespective of whether or not that particular combination has been specifically enumerated in the accompanying claims at this time.

### APPENDIX A

### Glossary of Terms Use in Adept

Adept: ADdress Extrapolation using PoinTs, a computer program designed according to the invention.

Zip: US 5 digit postal code

Z4: A 4 digit extension to the US postal code that identifies a smaller segment of the Zip code area.

GEL: Generic Edit List—a log file of warning or errors that are output from the process which are then imported into a manual editing program

Gel'd: means to be put into a GEL or an error log

Beguile: A street network editing system that can be used with Adept.

mcdata: A file based geographic database

A**: Road type designation. A** road designations include:
A1* (highways);
A63 (ramps);
A74 (driveways);
A65, 66, 68, 69 (ferries);
A73 (alleys);
A75 (parking lots);
A64 (service roads);
A60 (connecting roads); and
A62 (traffic circles, walkways and 4-wheel-drive roads)

DD: Short for Double Digitized, a chain is double digitized when it represents a dual carriageway.

Valence: a measure of the number of chains that meet at a given node (junction between two segments). Junctions occur on nodes.

V1: Valence one junction (a dead end)

V2: Valence two junction (two chains intersect at this junction)

V3: Valence three junction (more than two chains intersect at this junction)

CC: Confidence Code—an internal metadata system which rates and ranks the source of attribution contained within the geographic database.

Dups: Duplicates

LF, LT, RF, RT: Left From, Left To, Right From, Right To

### APPENDIX B

### Adept's Command Line

Adept is run with the following command line:

```
adept mcdata [−wr minlon minlat maxlon maxlat] [−zip nnnnn] [−in file]
    [−cty fips] [−p] [−it percent] [−br] [+update] [−ts xx] [−cc xx]
    [+cc xx] [−limits] [+cds] [−amb] [−o dir] [−debug]
```

The mcdata is a file based geographic database, and the path for this database must be specified for Adept to run. Each of the components of the command line is explained below. See Appendix A for additional terminology.

−wr

This flag specifies that adept should use addresses within a rectangle define by four coordinates (minion, minlat, maxlon and maxlat), where each coordinate is a value of latitude or longitude. It is important to be careful since partial chains will be created and calculated at the borders of this rectangle, causing possible overlaps with neighbouring rectangles.

−zip nnnnn

If the −zip flag is used then chains are arranged by zip code as well as by name. nnnnn is the zip code to be used, and only addresses in this zip will be processed. Again, partial chains will be calculated where a street crosses out of a zip code, causing possible overlaps at the borders.

−in file

The −in flag is used to direct Adept to a text file of segment IDs, one id per line (the segs.txt format).

−cty fips

This flag indicates which FIPS (Federal Information Processing Standard) Adept is to use.

−br

Where this flag is used, Adept will not update bad address ranges, instead leaving the existing ranges in place. Errors will still be logged and gel'd as appropriate.

−p

This flag causes Adept to run in partial update mode. There are a variety of reasons why a whole chain may not be completely addressable using Adept. For example, there may be incorrect point addresses, missing ranges, overlaps or bad ‘guessing’. However, usually only a section of a chain will violate the addressing rules, and many ranges can be correctly inferred from the remainder of the chain. In partial update mode Adept will update any segment or side of an interval that can be readdressed using the Actual ranges, unless the −br flag is used, in which case the invalid ranges are not changed. In either case, Adept will create a gel of bad segments, that is blank segments and segments which contain range errors. The user can then go back and examine these segments and manually readdress them as required. Note that, often, the use of −p will result in overlaps between the readdressed segments and those segments that could not be readdressed.

−it percent

This value defines the percentage (0-100) of intervals in a chain that must be addressed in order to update a chain, in the case that an error is detected in that chain. By default, the percentage is 40%.

−ts xx

This value defines a target source of xx. Adept will only include chains that have points with source xx. Multiple −ts values can be used.

−aggr

This controls the use of aggressive correction techniques explained in greater detail below.

+cds

This flag causes Adept to readdress cul-de-sacs. This can result in geometry changes

−amb

With this flag Adept will attempt to resolve ambiguous points by the theta direction, that is the direction of the addresses in the rest of the street.

−o dir

With this flag dir is the directory where the output files will go

−cc xx

Adept will not update segments with Address Accuracy Confidence Code xx. Multiple ccs can be excluded by specifying mutliple −cc xx pairs

+cc xx

Adept will apply Address Accuracy Confidence Code xx to segments that have both sides successfully updated.

−limits

Adept will use first/last address of the selected segments as constraints.

+update
This flag must be specified for Adept to update the mcdata. Otherwise Adept will run in quality assurance mode.
−debug

This flag puts Adept in debug mode.

Several of these commands are specific to the US (−cty and −zip in particular). However, Adept is easily adapted to the standards and codes of another country's address system.

### APPENDIX C

### Gels

Many gels are created by Adept during its operation. Some of these are diagnostic, but others, in particular needswork.gel, must be examined by the user to complete the process of updating address ranges.

adept.gel

A ‘rectangle’ style gel is created that will encompass the street chain. You can then highlight the street for clarity and to display the address points for that street only. The address adjustment status (for both sides) is listed in the gel. This gel contains both [Pass] and [Fail] conditions for each side of each interval.

pass.gel
fail.gel

The adept.gel file is parsed into two separate gels, one containing all pass conditions, the other containing all fail conditions.

The remaining gels all have corresponding information in the log file. These gels are SegID gels which highlight a number of segments in Beguile using the segment IDs for those segments. (V3.gel is a Label X 1 gel)

imperr.gel—log file error code E01

This gel records imputer failures, which will also be recorded in unaddressed.gel

overlaps.gel—log file error code E02

This gel records overlapping segments for street results from McFindOverlaps( )

autofixed.gel—log file error code W01

This gel records ‘best guess’ corrections such as:
Parity correction (also logged in adept.log as AUTOFIX)
Sequence correction (also logged in adept.log as AUTOFIX)
Overlap correction (also logged in AddrCorr.log as AUTOFIX)
Z4 not in range warnings
   needswork.gel—log file error code W02

This gel records segments that have addressing errors due to Address Correction failures. These segments will retain their existing ranges if the −br flag was used. This gel also records imputer failures (also listed in imperr.gel).

notupdated.gel—log file error code W03

This gel records complete chains or sides that have address numbers, but too many errors to be updated. This gel also includes mixed parity chains. If the −p flag is used, failed chains may be partially addressed, but if there are too many errors then the chain is also logged to notupdated.gel. If −p is not used, all FAIL chain sides are not updated.

v3.gel—log file error code W04

This gel records valence three chains, chains that contain valence three nodes.

v2.gel—log file error code W05

This gel records valence two chains, chains that contain valence two nodes

v2v3.gel—log file error code W06

This gel records valence two chains that could also be valence three chains.

parity.gel—log file error code W07

This gel records parity and direction warnings.

readdressed.gel—log file error code W09

This gel records segments where there were originally no addresses, but Adept has added addresses. Also records segments where adept removed address ranges.

confcode.gel—log file error code W11

This gel records not updated segments that are protected by a specified confidence code

ambiguous.gel—log file error code W12

This gel records segments which were the one addressed segments in their chain and had all the points on one or both sides at the same location, so that direction etc could not be determined.

breaks.gel—log file error code W13

This gel records street chains where numbers across junctions differ by more than 300.

w99.gel—log file error code W99

This gel records where Adept has determined that a chain has a different direction or parity to existing records

work.gel contains a list of all gel'd segments, grouped by chain Id, except for error codes W04 and W05.

### APPENDIX D

### Other Output Files

As well as the gel files listed in Appendix C, Adept will generate a number of other detailed output files. These can be used to get more information for items in the gel files.

adept.log

A summary of processing, this file includes PASS/FAIL details, statistics, errors and warnings.

errors.log

This log file records fatal update errors.

warnings.log

This log file records miscellaneous warnings, including:
not in Z4
opposite direction (W09)
different direction, parity (W99)
not updated due to existing CC (W11)
range exceeded
   adept.sum

This file is a summary of existing, actual and calculated potential addresses between each junction of each chain, provided that there were address points on that chain, and only for chains that have actual addresses that could successfully be converted.

For each interval, the segments that comprise the interval are listed, along with each segment's existing range and the junction's potential range.

If the chain could not be corrected, the reason is listed in this file.

An example of an entry in adept.sum might look like:
====SOUCY RD Left: Range Corrected
====SOUCY RD Right: Range Corrected
Chain#4 Street SOUCY RD:
X1: (16988->16995): Seglds 16996
   Potential L: 598-550 R: 599-551
   Actual L: 556-556 R: −
   Existing L: 200-218
   Existing R: 201-219
X2: (16995->17028): Seglds 16994
   Potential L: 548-500 R: 549-475/491
   Actual L: −R: 531-493
   Existing L: 220-258
   Existing R: 221-259
X3: (17028->16997): Seglds 16982
   Potential L: 498-450 R: 475/489-301
   Actual L: 452-452 R: 475/489-475/489
   Existing L: 260-288
   Existing R: 261-289
X4: (16997->17373): Seglds 16914 16968
   Potential L: 448-426 R: 299-291
   Actual L: −R: 459-259/263
   Existing L: 290-296 298-386
   Existing R: 291-297 299-387
X5: (17373->16781): Seglds 16894 16841 16820 16792
   Potential L: 424-410 R: 289-277
   Actual L: −R: 289-289
   Existing L: 388-422 424-456 458-582 584-588
   Existing R: 389-423 425-457 459-583 585-589
X6: (16781->16777): Seglds 16780 16778
   Potential L: 408-400 R: 275-201
   Actual L: −R: −
   Existing L: 590-594 596-598
   Existing R: 591-595 597-599
      adept.chg

A summary of the addresses changed, listed by intervals. For each interval, the segments that comprise the interval are listed, along with each segment's existing range and the junction's potential range.

An example of an entry in adept.chg might look like:
====RIVER RD Left
Interval 1 Segld(s): 16989 16896
   398-348 346-228>>398-100
Interval 2 Segld(s): 16852 16828
   226-194 192-84>>98-72
Interval 3 Segld(s): 16790
   1-81>>70-2
      adept.dbg

This file is a detailed chaining and address information log. It contains a list of all the segments and junctions in each chain. The number of address points for each segment is also logged.

The consolidated results in adept.dbg also show all the segments between junctions, and the actual address range from the points.

The address correction status (PASS/FAIL) is shown for each side of each chain. If the status is PASS then the potential range between each junction for Left and Right Sides of the chain and the updated address range for each segment are logged.

An example of an entry in adept.dbg might look like:
Chain 1 FeatNum 1531: BROWN RD
Chain contains 7 Segs: 13615 13294 13257 13170 13114 13094 13078
Xstreet 1: (13614) MILITARY TPKE
Xstreet 3: (13256) EVERGREEN ST
Xstreet 4: (13169) CROSS RD
Xstreet 8: (13087) UNNAMED STREET
There are 27 address points for this chain
Consolidated results (actual):
X1: (13614->13256): Seglds 13615 13294 L: 3-73 R: 16-16
X2: (13256->13169): Seglds 13257 L: 85-85 R: −
X3: (13169->13087): Seglds 13170 13114 13094 13078 L: 91-111 R: 98-114
Street(L): BROWN RD [PASS]
Potential Range#1: 1-75
Potential Range#2: 77-85
Potential Range#3: 87-199
Street(R): BROWN RD [PASS]
Potential Range#1: 2-48
Potential Range#2: 50-74
Potential Range#3: 76-198
Street Theta is 13035 based on segld 13615
NewSegRange: 13615 1-67 ZZ1-ZZ909
NewSegRange: 13294 69-75 ZZ911-ZZ1001
NewSegRange: 13257 77-85 ZZ1-ZZ1001
NewSegRange: 13170 87-103 ZZ1-ZZ161
NewSegRange: 13114 105-125 ZZ163-ZZ345
NewSegRange: 13094 127-159 ZZ347-ZZ649
NewSegRange: 13078 161-199 ZZ651-ZZ1001
NewSegRange: 13615 ZZ1-ZZ909 2-42
NewSegRange: 13294 ZZ911-ZZ1001 44-48
NewSegRange: 13257 ZZ1-ZZ1001 50-74
NewSegRange: 13170 ZZ1-ZZ161 76-94
NewSegRange: 13114 ZZ163-ZZ345 96-118
NewSegRange: 13094 ZZ347-ZZ649 120-156
NewSegRange: 13078 ZZ651-ZZ1001 158-198

### AddrCorr.log

This is a detailed log of the address correction results for each side of the street chain (Left first, then Right). The original actual address ranges between junctions is shown first, followed by the range derived by Adept after checking for validity and minor adjustments. Gaps may exist at this point.

Next gaps are removed (if possible) by using addresses from preceding and following ranges.

Lastly, the calculated potential range is logged.

An example of an entry in AddrCorr.log might look like:
Original BROWN RD:
Range#1 3-73 (Range is Valid/Addressed)
Range#2 85-85 (Range is Valid/Addressed)
Range#3 91-111 (Range is Valid/Addressed)
RangeParity is 4
RangeDirection is 8
Addressed Ranges:
Range#1: 3-73
Range#2: 85-85
Range#3: 91-111
Gap Adjusted:
Range#1: 3-73
Range#2: 85-85
Range#3: 91-111
Potential BROWN RD:
Range#1: 1-75
Range#2: 77-85
Range#3: 87-199
Final Check: PASS
Original BROWN RD:
Range#1 16-16 (Range is Valid/Addressed)
Range#2-(Range is Valid/Not Addressed)
Range#3 98-114 (Range is Valid/Addressed)
RangeParity is 2
RangeDirection is 8
Addressed Ranges:
Range#1: 16-16
Range#3: 98-114
Theres a gap between 1 and 3
Gap Adjusted:
Range#1: 16-16
Range#2: 56-56
Range#3: 98-114
Potential BROWN RD:
Range#1: 2-48
Range#2: 50-74
Range#3: 76-198
Final Check: PASS

### AddrRange.txt

This file can be used to run the Address Correction program, that ordinarily forms a part of Adept, in standalone mode. It is a list of all actual ranges (LeftFrom, LeftTo, RightFrom and RightTo) for each interval for each street chain.

An example of an entry in AddrRange.txt might look like:
StreetName=BROWN RD (Chainld 1)
3, 73, 16, 16
85, 85,
91, 111, 98, 114
<End>

1. A method for converting a database of point address data into a database of address range data using a computer, wherein each point address comprises an address number, a street name and a geographical location, the method comprising:
assigning each point address to a chain based upon its street name;
ordering the point addresses in each chain according to their geographical location;
determining the direction and range of the road numbers in at least part of at least one chain; and
storing the direction and range data as address range data.

2. The method of claim 1, further comprising:
finding the junctions between chains by noting points where chains meet; and
dividing at least one chain into intervals, each interval being defined as a section of chain between two subsequent junctions,
before determining the direction and range of the address numbers in at least part of at least one interval and storing the direction and range data as address range data.

3. The method of claim 1, further comprising:
dividing at least one chain or interval into sides, each side of a chain or interval corresponding to a side of the street,
before determining the direction and range of the address numbers in at least part of at least one side and storing the direction and range data as address range data.

4. The method of claim 3, further comprising:
determining the parity of the address numbers in at least part of at least one side.

5. The method of claim 1, further comprising:
checking and correcting the point address data,
before determining the direction and range of the address numbers in at least part of at least one side and storing the direction and range data as address range data.

6. The method of claim 5, wherein the point address data is checked by analysing the address numbers, street names and geographical locations to ensure that they comply with an expected format.

7. The method of claim 5, wherein the point address data is checked by determining the prevailing direction of count of address numbers for at least part of at least one chain and
the point address data is corrected by swapping, deleting or replacing any address numbers which are out of position given the prevailing direction of count.

8. The method of claim 5, wherein the point address data is checked by determining the prevailing parity of address numbers for at least part of at least one chain and
the point address data is corrected by swapping, deleting or replacing any address numbers which are out of position given the prevailing parity.

9. The method of claim 5, wherein the point address data is checked by searching for gaps in the address numbers of at least part of at least one chain and
the point address data is corrected by creating new address numbers in that gap.

10. The method of claim 1, further comprising checking and correcting the address range data.

11. A method for checking a first set of address range data in a database, the method comprising:
acquiring point address data for the area to be checked;
converting the point address data into a second set of address range data using a method according to claim 1; and
checking the first set of address range data against a second set of address range data.

12. A method for compressing point address data, the method comprising converting the point address data into a set of address range data using a method according to claim 1.

13. A computer program product directly loadable into the internal memory of a digital computer, comprising computer software code for performing a method as claimed in claim 1.
